(19) United States
(12) Patent Application Publication
(10) Pub. No.: US 2018/0156351 A1
(43) Pub. Date: Jun. 7, 2018

(54) SUBSEA VALVE POSITION INDICATOR

(71) Applicant: Siemens Aktiengesellschaft, Munich (DE)

(72) Inventors: Andrew Robert EASTOE, Urangsvaeg (NO); Bjoern-Aksel HAUGLAND, Foldroeyhamn (NO); Jan Inge FOLGEROE-HOLM, Foldroyhamn (NO)

(73) Assignee: Siemens Aktiengesellschaft, Munich (DE)

(21) Appl. No.: 15/831,465

(22) Filed: Dec. 5, 2017

(30) Foreign Application Priority Data
Dec. 7, 2016 (EP) 16202613.2

(51) Int. Cl. F16K 37/00; F16K 31/08; E21B 47/09

(52) U.S. Cl. CPC F16K 37/0008; E21B 34/06; E21B 47/0905; F16K 31/084

(57) ABSTRACT

A valve position indicator is for reading the position of a valve shutter of a valve associated to the valve position indicator. In an embodiment, the valve position indicator includes a body; at least two linear sensors; and a coupling device for coupling the valve position indicator to the valve in such a way that the at least two linear sensors are adjacent to a travelling path of a magnet attached to the valve shutter.

### PRIORITY STATEMENT

The present application hereby claims priority under 35 U.S.C. § 119 to European patent application number EP 16202613.2 filed Dec. 7, 2016, the entire contents of which are hereby incorporated herein by reference.

### FIELD

At least one embodiment of the present invention generally relates to a valve position indicator. The valve position indicator of at least one embodiment of the present invention is particularly adaptable to a valve position indicator for a subsea valve. Particularly, but not exclusively, at least one embodiment of the present invention relates to a valve position indicator for a subsea linear valve or to valve having a stem, whose movement can be associated to a linear movement of a magnetic device.

### BACKGROUND

In many technical fields, for example in the subsea field, valves and actuators are utilized in operative conditions where the valve is physically located remote from the control and monitoring facility. It is nevertheless necessary to know when the valve shutter is in the open or closed or intermediate position, to determine their operative conditions and to provide proper control. For this purpose, electrical signals have been used to transfer information about the valve closure degree to a remote control facility.

### SUMMARY

The inventors have recognized that in known systems, inconveniences may occur when the electrical signal fails or in the event that erroneous electrical signals are generated.

The inventors have further recognized that, when the electrical signal fails as a result of a damage to the position sensor in the valve position indicator, no control of the valve is possible before the damage is detected and repaired. Finally, the inventors have recognized that, in the event an erroneous signal is sent to the control and monitoring facility, falsely indicating the position of a remote valve, severe damage may be caused.

At least one embodiment of the present invention provides a valve position indicator, which is reliable, secure and cost-effective.

At least one embodiment of the present invention is directed to a valve position indicator. The claims describe advantageous developments and modifications of the invention.

According to at least one embodiment of the present invention, a valve position indicator for reading the position of a valve shutter of a valve associated to the valve position indicator includes:

a body,

at least two linear sensors, and

a coupling device for coupling the valve position indicator to the valve in such a way that the at least two linear sensors are adjacent to a travelling path of a magnet connected to the valve shutter.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment, but to which the invention is not limited.

FIG. 1 shows an axonometric view of a first embodiment of a valve position indicator according to the present invention,

FIG. 2 shows a lateral view of the valve position indicator of FIG. 1,

FIG. 3 shows a frontal view of the valve position indicator of FIG. 1,

FIG. 4 shows a sectional view of the valve position indicator of FIG. 1, according to the sectional line IV-IV of FIG. 3,

FIG. 5 shows a sectional view of the valve position indicator of FIG. 1, according to the sectional line V-V of FIG. 4,

FIG. 6 shows an axonometric view of a second embodiment of a valve position indicator according to the present invention,

FIG. 7 shows a frontal view of the valve position indicator of FIG. 6.

### DETAILED DESCRIPTION OF THE EXAMPLE EMBODIMENTS

The illustrations in the drawings are schematic. It is noted that in different figures, similar or identical elements are provided with the same reference signs, also when they refer to different embodiments of the invention.

In the following, embodiments of the invention are described in detail with reference to the accompanying drawings. It is to be understood that the following description of the embodiments is given only for the purpose of illustration and is not to be taken in a limiting sense. It should be noted that the drawings are to be regarded as being schematic representations only, and elements in the drawings are not necessarily to scale with each other. Rather, the representation of the various elements is chosen such that their function and general purpose become apparent to a person skilled in the art.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

According to at least one embodiment of the present invention, a valve position indicator for reading the position of a valve shutter of a valve associated to the valve position indicator includes:

a body,

at least two linear sensors, and

a coupling device for coupling the valve position indicator to the valve in such a way that the at least two linear sensors are adjacent to a travelling path of a magnet connected to the valve shutter.

According to a possible embodiment of the present invention, the linear sensors are a series of resistors connected to parallel coupled reed switches. In particular, the linear sensors may be parallel to each other. Also the travelling path may parallel to the at least two reed switches.

Advantageously, the redundancy provided by the at least two linear sensors achieve redundancy and add security with respect to failures. Cost benefits derive from the fact that a plurality of sensors is integrated in a single indicator.

This allows valve position indicator to be efficiently coupled to a subsea valve, in particular a subsea valve including a linear shutter or a subsea valve, whose shutter movement can actuate the movement of the magnet along the travelling path.

According to a first possible embodiment, the body includes a cavity, inside which the travelling path is defined.

According to a second possible embodiment, the body includes an external surface, adjacent to which the travelling path is defined. In particular, in operation, the external surface may interposed between the travelling path and the at least two linear sensors.

According to embodiments of the present invention, the travelling path is equidistant from the at least two linear sensors. This assures that the measurements performed by the two sensors are identical.

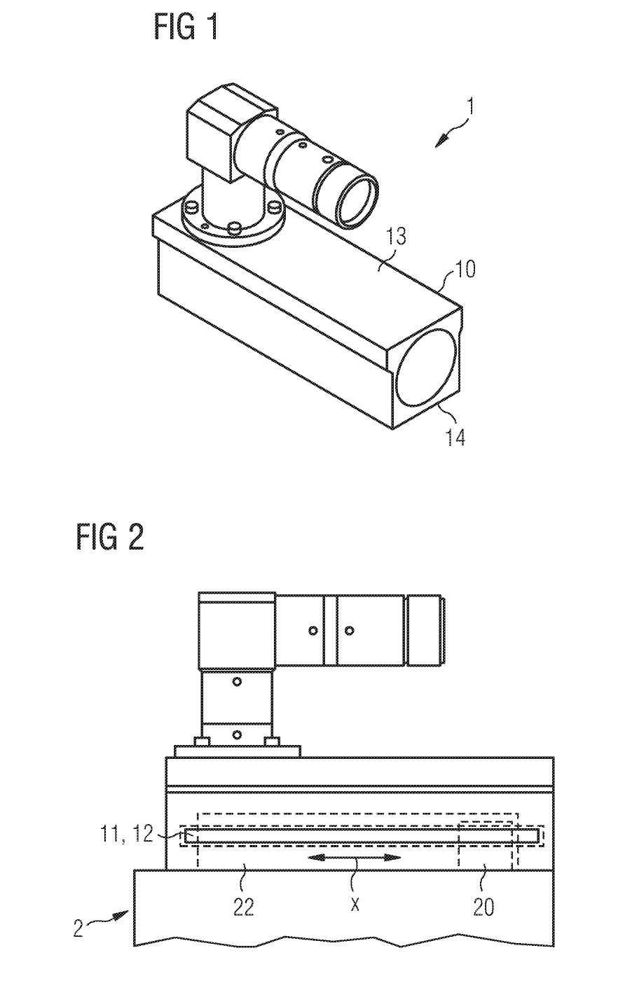

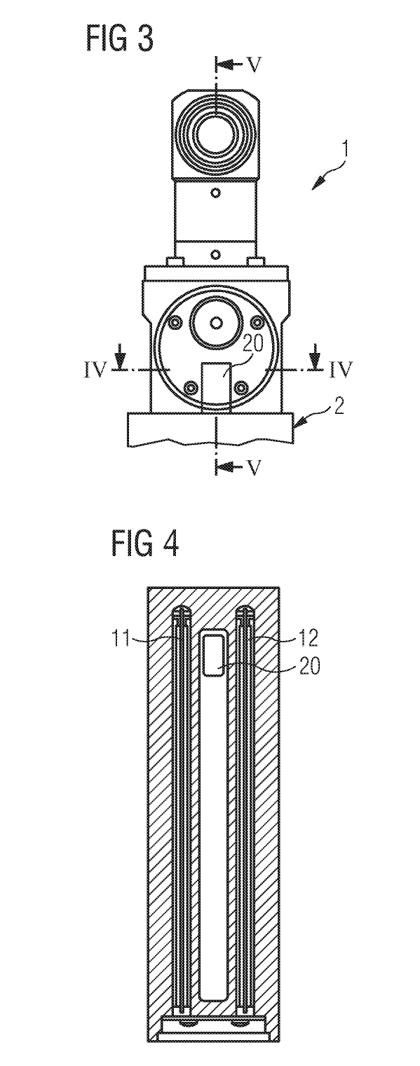

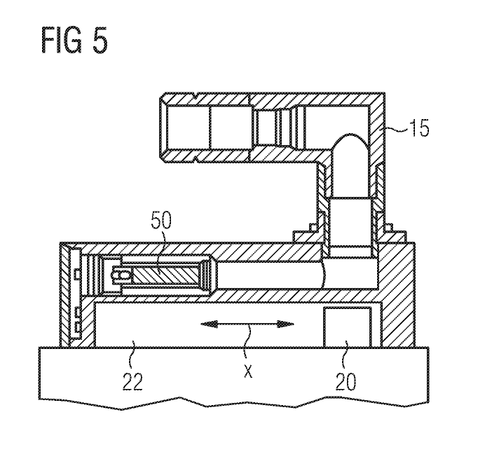

FIGS. 1 to 5 shows a first embodiment of a valve position indicator 1 for reading the position of a valve shutter (not shown) of a subsea valve 2 (only schematically represented in the attached figures) associated to the valve position indicator 1.

The subsea valve 2 includes a stem (not shown) connected to a shutter of the valve. The shutter may linear or rotational. The stem is further connected to a magnet 20 in such a way that the movement of the stem between an opened and a closed position of the subsea valve determines the movement of the magnet 20 along a linear travelling path, symbolically represented in the attached figure by the double arrow X.

The valve position indicator 1 includes a body 10 having the shape of a parallelepiped with an upper face 13 and an opposite lower face 14. On the upper face 13 a connector 15 is provided for connecting the valve position indicator 1 to a supporting structure (not shown). The connector 15 is hollow to allow the passage of the electrical connection (not shown) powering the valve position indicator 1.

In the body 10 a cavity 22 opened at the lower face 14. The cavity 22 has a parallelepiped shape and is dimensioned in such a way to provide, in operation, i.e. when the valve position indicator 1 is coupled with the subsea valve 2, housing for the magnet 20.

The travelling path X is defined inside the cavity 22. This means that, in operation, the magnet 20 travels along the travelling path X while moving, at least in part, within the cavity 20.

The valve position indicator 1 and the subsea valve 2 comprise respective coupling device (not shown in the attached figures) to be coupled together in such a way that the above conditions is achieved.

The body 10 further includes two linear position sensors 11, 12, for measuring the position of the magnet 20 along the travelling path X. For the linear position sensors 11, 12 two respective reed switches are used, place in respective cavities adjacent to the cavity 22. The linear position sensors 11, 12 are equidistant from the lower face 14 and equidistant from the travelling path X. The two linear position sensors 11, 12 and the travelling path X are parallel to each other.

According to other possible embodiments (not shown) of the invention, the valve position indicator 1 includes more than two linear sensors, all capable of measuring the position of the magnet 20 along the travelling path X.

The body 10, between the linear position sensors 11, 12 and the upper surface 13, comprises a plurality of electronic devices 50 for receiving the information about the position of the magnet 20 from the linear position sensors 11, 12 and transmitting them outside the valve position indicator 1 through the hollow connector 15. The electronics 50 of the valve position indicator 1 are conventional and known in the art and for this reason not described in further details.

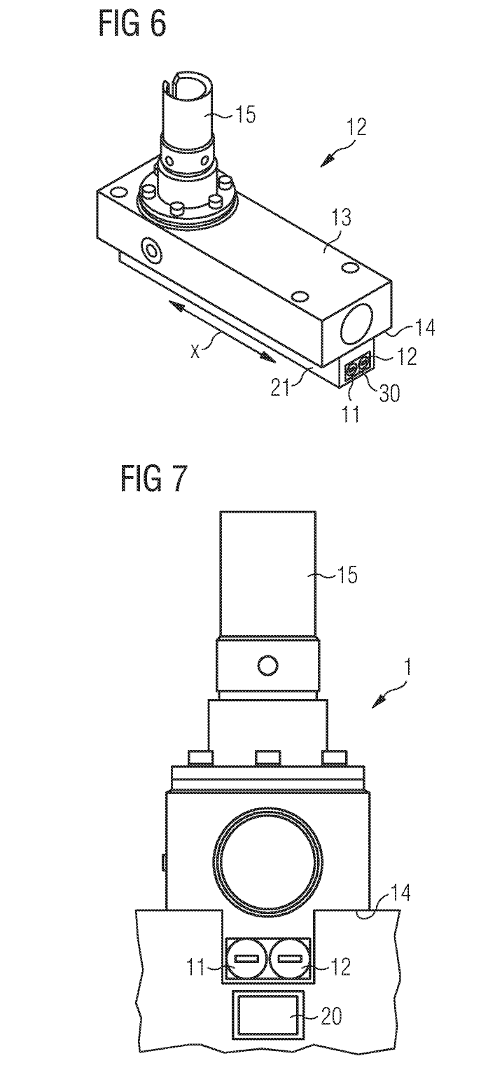

FIGS. 6 and 7 shows a second embodiment of a valve position indicator 1a for reading the position of a valve shutter (not shown) of a subsea valve 2 (only schematically represented in the attached figures) associated to the valve position indicator 1. The valve position indicator 1a is basically identical to valve position indicator 1 of the first embodiment, with the main difference that the body 10 do not include the cavity 22 for housing the magnet 20. Instead the valve position indicator 1a includes a protrusion 21 extending from the lower surface 14 of the body. The linear position sensors 11, 12 (reed switches) are provided in the protrusion 21, adjacent to an external surface 30 of the protrusion 21. In operation, the travelling path X of the magnet 20 is adjacent to the external surface 30, on the opposite side with respect to the linear position sensors 11, 12. In other words, in operation, the external surface 3 is interposed between the travelling path X of the magnet 20 and the linear position sensors 11, 12.

Also in this second embodiment, the travelling path X of the magnet 20 is parallel and equidistant to the linear position sensors 11, 12.

In all the embodiments of the present invention, the failing or not correct working of one of the linear position sensors 11, 12 does not prevent the position of the magnet 20 to be read, thanks to the redundancy provided by another of the linear position sensors 11, 12.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A valve position indicator for reading a position of a valve shutter of a valve associated to the valve position indicator, the valve position indicator comprising:
a body;
at least two linear sensors; and
a coupling device to couple the valve position indicator to the valve such that the at least two linear sensors are adjacent to a linear travelling path of a magnet of the valve connected to the valve shutter.

2. The valve position indicator of claim 1, wherein the at least two linear sensors are a series of resistors connected to parallel coupled reed switches.

3. The valve position indicator of claim 1, wherein the body includes a cavity, the travelling path being defined inside the cavity.

4. The valve position indicator of claim 1, wherein the body includes an external surface, the travelling path being defined adjacent to the external surface.

5. The valve position indicator of claim 3, wherein the travelling path is equidistant from the at least two linear sensors.

6. The valve position indicator of claim 4, wherein, in operation, the external surface is interposed between the travelling path and the at least two linear sensors.

7. The valve position indicator of claim 1, wherein the at least two linear sensors are arranged in parallel.

8. The valve position indicator of claim 7, wherein the travelling path is parallel to the at least two linear sensors.

9. A valve for subsea application, comprising:
the valve position indicator of claim 1.

10. The valve of claim 9, further comprising a linear shutter.

11. The valve position indicator of claim 2, wherein the body includes a cavity, the travelling path being defined inside the cavity.

12. The valve position indicator of claim 2, wherein the body includes an external surface, the travelling path being defined adjacent to the external surface.

13. The valve position indicator of claim 4, wherein the travelling path is equidistant from the at least two linear sensors.

14. The valve position indicator of claim 11, wherein the travelling path is equidistant from the at least two linear sensors.

15. The valve position indicator of claim 12, wherein the travelling path is equidistant from the at least two linear sensors.

16. The valve position indicator of claim 12, wherein, in operation, the external surface is interposed between the travelling path and the at least two linear sensors.

17. A valve for subsea application, comprising:
the valve position indicator of claim 2.

18. The valve of claim 17, further comprising a linear shutter.

19. A valve for subsea application, comprising:
the valve position indicator of claim 3.

20. The valve of claim 19, further comprising a linear shutter.
